(19) United States
(12) Patent Application Publication
(10) Pub. No.: US 2025/0136829 A1
(43) Pub. Date: May 1, 2025

(54) COATING COMPOSITIONS, COATED STRUCTURES, AND METHODS FOR MAKING THE SAME

(71) Applicant: ARMSTRONG WORLD INDUSTRIES, INC., Lancaster, PA (US)

(72) Inventors: Ying CHANG, Lancaster, PA (US); Timothy ASTON, Columbia, PA (US)

(21) Appl. No.: 18/924,811

(22) Filed: Oct. 23, 2024

Related U.S. Application Data
(60) Provisional application No. 63/546,694, filed on Oct. 31, 2023.

(51) Int. Cl. C09D 7/61; C08K 3/013; C08K 3/22; C08K 3/26; C08K 3/34; C08K 3/38; C09D 5/14; C09D 131/04

(52) U.S. Cl. CPC C09D 7/61; C08K 3/013; C08K 3/346; C09D 5/14; C09D 131/04; C08K 2003/2227; C08K 2003/2241; C08K 2003/265; C08K 2003/387

(57) ABSTRACT

Disclosed is a coating composition suitable for application to an acoustic panel. The coating composition includes a Pigment blend. The Pigment blend includes calcium carbonate, titanium dioxide, calcined diatomaceous earth, and aluminum hydroxide. The coating composition further includes a clay and a biocide including zinc. The coating composition further includes a binder. A ratio of pigment-to-binder is from about 3:1 to about 30:1. Also disclosed are building panels coated with the coating composition and methods for their formation.

### CROSS-REFERENCE TO RELATED APPLICATIONS

This application claims the benefit of U.S. Provisional Patent Application No. 63/546,694 filed on Oct. 31, 2023, the disclosure of which is incorporated herein by reference in its entirety.

### FIELD OF THE DISCLOSURE

The present disclosure relates to coating compositions for coating panels, such as ceiling and wall panels, and more particularly to coating compositions having antimicrobial properties.

### BACKGROUND

Building materials, such as planks and panels for ceiling and wall systems, are commonly coated with coating compositions, such as paints, for aesthetic purposes. Building materials and coating compositions may be designed balance interests with respect to aesthetics, material cost, structural integrity, acoustics, and environmental impact.

Accordingly, those skilled in the art continue research and development in the field of coating compositions for building panels.

### SUMMARY

This summary is intended merely to introduce a simplified summary of some aspects of one or more implementations of the present disclosure. Further areas of applicability of the present disclosure will become apparent from the detailed description provided hereinafter. This summary is not an extensive overview, nor is it intended to identify key or critical elements of the present teachings, nor to delineate the scope of the disclosure. Rather, its purpose is merely to present one or more concepts in simplified form as a prelude to the detailed description below.

Applicants have discovered coating compositions useful for application on acoustic panels, such as wall or ceiling panels.

In one example, the disclosed coating composition includes a Pigment blend including two or more of calcium carbonate, titanium dioxide, calcined diatomaceous earth, and aluminum hydroxide. The coating composition further includes a clay and a biocide including zinc. The coating composition further includes a binder in an amount such that a ratio of pigment-to-binder is from about 3:1 to about 30:1.

In certain examples, the pigment-to-binder ratio is about 5:1 to about 25:1. In certain examples, the binder comprises vinyl acrylic polymer. In certain examples, the binder is present in an amount from about 2 wt. % to about 20 wt. %, from about 2 wt. % to about 18 wt. %, or from about 3 wt. % to about 16 wt. %, based on the dry weight of the composition. In certain examples, the titanium dioxide is present at a concentration of about 0.1 wt. % to about 35 wt. %, from about 0.5 wt. % to about 4 wt. %, or from about 1 wt. % to about 3 wt. %, based upon the dry weight of the composition. In certain examples, the calcined diatomaceous earth is present in an amount from about 3 wt. % to about 20 wt. %, from about 5 wt. % to about 17.5 wt. %, or from about 7.5 wt. % to about 15 wt. %, based on the dry weight of the composition. In certain examples, the aluminum hydroxide is present in an amount from about 3 wt. % to about 20 wt. %, from about 5 wt. % to about 18 wt. %, or from about 10 wt. % to about 15 wt. %, based on the dry weight of the composition. In certain examples, the calcium carbonate is present in an amount from about 20 wt. % to about 60 wt. %, from about 25 wt. % to about 35 wt. %, or from about 27.0 wt. % to about 32.5 wt. %, based on the dry weight of the composition. In certain examples, the coating composition includes water present in an amount from about 10 wt. % to about 20 wt. %, from about 12 wt. % to about 18 wt. %, or from about 13 wt. % to about 15 wt. %, based upon the wet weight of the composition. In certain examples, the coating composition includes a hydrophobic polymer emulsion present in an amount from about 0.1 wt. % to about 30 wt. %, from about 0.5 wt. % to about 5.0 wt. %, or from about 0.75 wt. % to about 3 wt. %, based on the dry weight of the composition. In certain examples, the coating composition includes a wetting and dispersing additive comprising an anionic copolymer having an acid value of about 2 mg KOH/g and present in an amount from about 0.1 wt. % to about 5 wt. %, from about 0.1 wt. % to about 2 wt. %, or from about 0.1 wt. % to about 0.5 wt. %, based on the dry weight of the composition. In certain examples, the coating composition includes hectorite or bentonite clay, present in an amount from about 0.01 wt. % to about 5 wt. %, from about 0.03 wt. % to about 2 wt. %, or from about 0.03 wt. % to about 0.5 wt. %, based on the dry weight of the composition. In certain examples, the coating composition includes a defoamer, such as wax and mineral oil, present in an amount from about 0.01 wt. % to about 2 wt. %, from about 0.01 wt. % to about 1 wt. %, or from about 0.01 wt. % to about 0.1 wt. %, based on the dry weight of the composition. In certain examples, the coating composition includes one or more biocides present in an amount from about 0.01 wt. % to about 1 wt. %, from about 0.05 wt. % to about 0.5 wt. %, or from about 0.05 wt. % to about 0.4 wt. %, based on the dry weight of the composition. In certain examples, the pigment blend of the coating composition includes precipitated synthetic silicate present in an amount from 1 wt. % to about 25 wt. %, from about 1.5 wt. % to about 3.5 wt. %, or from about 2 wt. % to about 3 wt. %, based on the dry weight of the composition. In certain examples, the pigment blend of the coating composition includes a calcined extender present in an amount from about 1 wt. % to about 6 wt. %, from about 2 wt. % to about 5 wt. %, or from about 3 wt. % to about 4 wt. %, based on the dry weight of the composition.

Also disclosed are panels.

In one example, the acoustic panel has a first major surface opposite a second major surface and a side surface extending there-between, the acoustic panel is coated on at least one surface with a coating composition. The coating composition includes a pigment blend. The pigment blend includes two or more of calcium carbonate, titanium dioxide, calcined diatomaceous earth, and aluminum hydroxide. The coating composition further includes a clay and a biocide including zinc. The coating composition further includes a binder in an amount such that a ratio of pigment-to-binder is from about 3:1 to about 30:1.

In certain examples, the pigment-to-binder ratio is about 5:1. In certain examples, the binder comprises vinyl acrylic polymer present in an amount from about 2 wt. % to about 20 wt. %, from about 2 wt. % to about 18 wt. %, or from about 3 wt. % to about 16 wt. %, based on the dry weight of the composition. In certain examples, the titanium dioxide is present at a concentration of about 0.1 wt. % to about 35 wt. %, from about 0.5 wt. % to about 4 wt. %, or from about 1 wt. % to about 3 wt. %, based upon the dry weight of the composition. In certain examples, the calcined diatomaceous earth is present in an amount from about 3 wt. % to about 20 wt. %, from about 5 wt. % to about 17.5 wt. %, or from about 7.5 wt. % to about 15 wt. %, based on the dry weight of the composition. In certain examples, the aluminum hydroxide is present in an amount from about 3 wt. % to about 20 wt. %, from about 5 wt. % to about 18 wt. %, or from about 10 wt. % to about 15 wt. %, based on the dry weight of the composition. In certain examples, the calcium carbonate is present in an amount from about 20 wt. % to about 60 wt. %, from about 25 wt. % to about 35 wt. %, or from about 27.0 wt. % to about 32.5 wt. %, based on the dry weight of the composition. In certain examples, the coating composition of the acoustic panel further includes water present in an amount from about 10 wt. % to about 30 wt. %, from about 12 wt. % to about 18 wt. %, or from about 13 wt. % to about 15 wt. %, based upon the wet weight of the composition. In certain examples, the coating composition of the acoustic panel includes a hydrophobic polymer emulsion present in an amount from about 0.1 wt. % to about 30 wt. %, from about 0.5 wt. % to about 5.0 wt. %, or from about 0.75 wt. % to about 3 wt. %, based on the dry weight of the composition. In certain examples, the coating composition of the acoustic panel includes a wetting and dispersing additive comprising an anionic copolymer having an acid value of about 2 mg KOH/g present in an amount from about 0.1 wt. % to about 5 wt. %, from about 0.1 wt. % to about 2 wt. %, or from about 0.1 wt. % to about 0.5 wt. %, based on the dry weight of the composition. In certain examples, the coating composition of the acoustic panel includes hectorite or bentonite clay, present in an amount from about 0.01 wt. % to about 5 wt. %, from about 0.03 wt. % to about 2 wt. %, or from about 0.03 wt. % to about 0.5 wt. %, based on the dry weight of the composition. In certain examples, the coating composition of the acoustic panel includes a defoamer, such as wax and mineral oil, present in an amount from about 0.01 wt. % to about 2 wt. %, from about 0.01 wt. % to about 1 wt. %, or from about 0.01 wt. % to about 0.1 wt. %, based on the dry weight of the composition. In certain examples, the biocide includes zinc borate present in an amount from about 0.01 wt. % to about 1 wt. %, from about 0.05 wt. % to about 0.5 wt. %, or from about 0.05 wt. % to about 0.4 wt. %, based on the dry weight of the composition. In certain examples, the Pigment blend includes precipitated synthetic silicate present in an amount from 1 wt. % to about 5 wt. %, from about 1.5 wt. % to about 3.5 wt. %, or from about 2 wt. % to about 3 wt. %, based on the dry weight of the composition. In certain examples, the pigment blend includes a calcined extender present in an amount from about 1 wt. % to about 25 wt. %, from about 2 wt. % to about 5 wt. %, or from about 3 wt. % to about 4 wt. %, based on the dry weight of the composition. In certain examples, the acoustic panel includes mineral fiber board, fiberglass, jute fiber, wood, or a composite material. In certain examples, the acoustic panel is a ceiling or wall panel.

In another example, the acoustic panel includes a substrate having a first major surface opposite a second major surface and a side surface extending there-between, a scrim having a first major scrim surface opposite a second major scrim surface, an adhesive adhering the first major substrate surface of the substrate to the second major scrim surface of the scrim, and a coating composition over the first major scrim surface. The coating composition includes a pigment blend having calcium carbonate, titanium dioxide, calcined diatomaceous earth, and aluminum hydroxide. The coating composition further includes a binder in an amount such that a ratio of Pigment-to-binder is from about 3:1 to about 30:1.

In certain examples, the pigment-to-binder ratio is about 5:1. In certain examples, the binder comprises vinyl acrylic polymer present in an amount from about 2 wt. % to about 30 wt. %, from about 2 wt. % to about 18 wt. %, or from about 3 wt. % to about 16 wt. %, based on the dry weight of the composition. In certain examples, the titanium dioxide is present at a concentration of about 0.1 wt. % to about 35 wt. %, from about 0.5 wt. % to about 4 wt. %, or from about 1 wt. % to about 3 wt. %, based upon the dry weight of the composition. In certain examples, the calcined diatomaceous earth is present in an amount from about 3 wt. % to about 20 wt. %, from about 5 wt. % to about 17.5 wt. %, or from about 7.5 wt. % to about 15 wt. %, based on the dry weight of the composition. In certain examples, the aluminum hydroxide is present in an amount from about 3 wt. % to about 20 wt. %, from about 5 wt. % to about 18 wt. %, or from about 10 wt. % to about 15 wt. %, based on the dry weight of the composition. In certain examples, the calcium carbonate is present in an amount from about 20 wt. % to about 60 wt. %, from about 25 wt. % to about 35 wt. %, or from about 27.0 wt. % to about 32.5 wt. %, based on the dry weight of the composition. In certain examples, the coating composition includes water present in an amount from about 10 wt. % to about 30 wt. %, from about 12 wt. % to about 18 wt. %, or from about 13 wt. % to about 15 wt. %, based upon the wet weight of the composition. In certain examples, the coating composition includes a hydrophobic polymer emulsion present in an amount from about 0.1 wt. % to about 35 wt. %, from about 0.5 wt. % to about 5.0 wt. %, or from about 0.75 wt. % to about 3 wt. %, based on the dry weight of the composition. In certain examples, the composition further includes a wetting and dispersing additive comprising an anionic copolymer having an acid value of about 2 mg KOH/g and present in an amount from about 0.1 wt. % to about 5 wt. %, from about 0.1 wt. % to about 2 wt. %, or from about 0.1 wt. % to about 0.5 wt. %, based on the dry weight of the composition. In certain examples, the coating composition includes clay, such as hectorite clay, present in an amount from about 0.01 wt. % to about 5 wt. %, from about 0.03 wt. % to about 2 wt. %, or from about 0.03 wt. % to about 0.5 wt. %, based on the dry weight of the composition. In certain examples, the coating composition includes a defoamer, such as wax and mineral oil, present in an amount from about 0.01 wt. % to about 2 wt. %, from about 0.01 wt. % to about 1 wt. %, or from about 0.01 wt. % to about 0.1 wt. %, based on the dry weight of the composition. In certain examples, the biocide includes zinc borate present in an amount from about 0.01 wt. % to about 1 wt. %, from about 0.05 wt. % to about 0.5 wt. %, or from about 0.05 wt. % to about 0.4 wt. %, based on the dry weight of the composition. In certain examples, the pigment blend includes precipitated synthetic silicate present in an amount from 1 wt. % to about 5 wt. %, from about 1.5 wt. % to about 3.5 wt. %, or from about 2 wt. % to about 3 wt. %, based on the dry weight of the composition. In certain examples, the Pigment blend includes a calcined extender present in an amount from about 1 wt. % to about 6 wt. %, from about 2 wt. % to about 5 wt. %, or from about 3 wt. % to about 4 wt. %, based on the dry weight of the composition. In certain examples, the acoustic panel includes mineral fiber board, fiberglass, jute fiber, wood, or a composite material. In certain examples, the scrim includes laminated non-woven glass fibers in a resin matrix. In certain examples, the adhesive includes a water based polyvinyl acetate emulsion. In certain examples, the acoustic panel is a ceiling or wall panel.

Also disclosed are methods for forming a building panel comprising a coating composition.

In one example, the method includes mixing two or more of calcium carbonate, titanium dioxide, calcined diatomaceous earth, and aluminum hydroxide with a clay and a biocide having zinc and a binder in an amount having a pigment-to-binder ratio of about 3:1 to about 30:1 with a solvent to form a mixed composition. The method further includes applying the mixed composition to a surface of an acoustic panel and drying the acoustic panel to evaporate the solvent to yield a dry coating composition.

In certain examples, the drying is performed at room temperature, between 20° C. to about 25° C. In certain examples, the solvent is water present in an amount from about 10 wt. % to about 35 wt. %, from about 12 wt. % to about 18 wt. %, or from about 13 wt. % to about 15 wt. %, based upon the wet weight of the composition. In certain examples, the pigment-to-binder ratio is about 5:1 to about 20:1. In certain examples, the binder comprises vinyl acrylic polymer present in an amount from about 2 wt. % to about 20 wt. %, from about 2 wt. % to about 18 wt. %, or from about 3 wt. % to about 16 wt. %, based on the dry weight of the composition. In certain examples, the titanium dioxide is present at a concentration of about 0.1 wt. % to about 5 wt. %, from about 0.5 wt. % to about 4 wt. %, or from about 1 wt. % to about 3 wt. %, based upon the dry weight of the composition. In certain examples, the calcined diatomaceous earth is present in an amount from about 3 wt. % to about 20 wt. %, from about 5 wt. % to about 17.5 wt. %, or from about 7.5 wt. % to about 15 wt. %, based on the dry weight of the composition. In certain examples, the aluminum hydroxide is present in an amount from about 3 wt. % to about 20 wt. %, from about 5 wt. % to about 18 wt. %, or from about 10 wt. % to about 15 wt. %, based on the dry weight of the composition. In certain examples, the calcium carbonate is present in an amount from about 20 wt. % to about 60 wt. %, from about 25 wt. % to about 35 wt. %, or from about 27.0 wt. % to about 32.5 wt. %, based on the dry weight of the composition. In certain examples, the coating composition includes a hydrophobic polymer emulsion present in an amount from about 0.1 wt. % to about 10 wt. %, from about 0.5 wt. % to about 5.0 wt. %, or from about 0.75 wt. % to about 3 wt. %, based on the dry weight of the composition. In certain examples, the composition includes a wetting and dispersing additive comprising an anionic copolymer having an acid value of about 2 mg KOH/g and present in an amount from about 0.1 wt. % to about 5 wt. %, from about 0.1 wt. % to about 2 wt. %, or from about 0.1 wt. % to about 0.5 wt. %, based on the dry weight of the composition. In certain examples, the coating composition includes hectorite clay or bentonite clay, present in an amount from about 0.01 wt. % to about 5 wt. %, from about 0.03 wt. % to about 2 wt. %, or from about 0.03 wt. % to about 0.5 wt. %, based on the dry weight of the composition. In certain examples, the coating composition includes a defoamer, such as wax and mineral oil, present in an amount from about 0.01 wt. % to about 2 wt. %, from about 0.01 wt. % to about 1 wt. %, or from about 0.01 wt. % to about 0.1 wt. %, based on the dry weight of the composition. In certain examples, the biocide includes zinc borate present in an amount from about 0.01 wt. % to about 1 wt. %, from about 0.05 wt. % to about 0.5 wt. %, or from about 0.05 wt. % to about 0.4 wt. %, based on the dry weight of the composition. In certain examples, the Pigment blend includes precipitated synthetic silicate present in an amount from 1 wt. % to about 5 wt. %, from about 1.5 wt. % to about 3.5 wt. %, or from about 2 wt. % to about 3 wt. %, based on the dry weight of the composition. In certain examples, the Pigment blend includes a calcined extender present in an amount from about 1 wt. % to about 6 wt. %, from about 2 wt. % to about 5 wt. %, or from about 3 wt. % to about 4 wt. %, based on the dry weight of the composition. In certain examples, the acoustic panel is a ceiling or wall panel. In certain examples, the mixed composition is applied to a scrim coupled to the acoustic panel.

Further areas of applicability of the present disclosure will become apparent from the detailed description provided hereinafter. It should be understood that the detailed description and specific examples, while indicating the preferred examples of the disclosure, are intended for purposes of illustration only and are not intended to limit the scope of the disclosure.

### DESCRIPTION OF THE DRAWINGS

The detailed description of the disclosure will be better understood when read in conjunction with the appended drawings. It should be understood, however, that the disclosure is not limited to the precise arrangements and instrumentalities of the examples shown in the drawings.

FIG. 1 is top perspective view of a coated building panel according to an example of the present disclosure;

FIG. 2 is a cross-sectional view of the coated building panel according to an example of the present disclosure, the cross-sectional view being along the II line set forth in FIG. 1;

FIG. 3 is cross-sectional view of a coated building panel according to an example of the present disclosure;

FIG. 4 is an example of a ceiling system comprising the coated building panel of the present disclosure;

FIG. 5 is a cross-sectional close-up view of the edges of building panels according to certain examples of the present disclosure;

FIG. 6 is a close-up view of a ceiling system comprising the coated building panel according to an example of the present disclosure, the close-up view being the portion identified by oval V in FIG. 4; and

FIG. 7 is a building system comprising one or more of the building panels of FIGS. 1 to 3.

### DETAILED DESCRIPTION

For illustrative purposes, the principles of the present disclosure are described by referencing various examples thereof. Although certain examples of the disclosure are specifically described herein, one of ordinary skill in the art will readily recognize that the same principles are equally applicable to, and can be employed in other applications and methods. It is to be understood that the disclosure is not limited in its application to the details of any particular example shown. The terminology used herein is for the purpose of description and not to limit the disclosure, its application, or uses.

As used herein and in the appended claims, the singular forms “a”, “an”, and “the” include plural references unless the context dictates otherwise. The singular form of any class of the ingredients refers not only to one chemical species within that class, but also to a mixture of those chemical species. The terms “a” (or “an”), “one or more” and “at least one” may be used interchangeably herein. The terms “comprising”, “including”, “containing”, and “having” may be used interchangeably. The term “include” should be interpreted as “include, but are not limited to”. The term “including” should be interpreted as “including, but are not limited to”.

As used throughout, ranges are used as shorthand for describing each and every value that is within the range. Any value within the range can be selected as the terminus of the range.

Unless otherwise specified, all percentages and amounts expressed herein and elsewhere in the specification should be understood to refer to percentages by weight of the total composition. Unless otherwise specified, reference to a molecule, or to molecules, being present at a “wt. %” refers to the amount of that molecule, or molecules, present in the composition based on the total weight of the composition. Unless otherwise specified, reference to a molecule, or to molecules, being present “based on the dry weight of the composition” refers to that molecule, or molecules, being present in the composition based on the total weight of the composition in a dry state. The “dry state” refers to solvent being present in the composition at an amount less than 5.0 wt. %, less than about 3.0 wt. %, less than about 1.0 wt. %; preferably less than about 0.5 wt. %, and more preferably less than about 0.25 wt. % of the composition. For example, a composition in the dry state may refer to a composition having about 95% solids, about 98% solids, preferably about 99% solids, or more preferably about 100% solids. By contrast, unless otherwise specified, reference to a molecule, or to molecules, being present “based on the wet weight of the composition” refers to that molecule, or molecules, being present in the composition based on the total weight of the composition which includes at least 5 wt. % of solvent.

According to the present application, use of the term “about” in conjunction with a numeral value refers to a value that may be +/−5% of that numeral. As used herein, the term “substantially free” is intended to mean an amount less than about 5.0 wt. %, less than 3.0 wt. %, less than 1.0 wt. %; preferably less than about 0.5 wt. %, and more preferably less than about 0.25 wt. % of the composition.

Unless defined otherwise, all technical and scientific terms used herein have the same meanings as commonly understood by one of ordinary skill in the art to which this disclosure belongs. All patents, patent applications, publications, and other references cited or referred to herein are incorporated by reference in their entireties for all purposes. In the event of a conflict in a definition in the present disclosure and that of a cited reference, the present disclosure controls.

In the description of examples disclosed herein, any reference to direction or orientation is merely intended for convenience of description and is not intended in any way to limit the scope of the present disclosure. Relative terms such as “lower,” “upper,” “horizontal,” “vertical,”, “above,” “below,” “up,” “down,” “top” and “bottom” as well as derivatives thereof (e.g., “horizontally,” “downwardly,” “upwardly,” etc.) should be construed to refer to the orientation as then described or as shown in the drawing (if applicable) under discussion. These relative terms are for convenience of description only and, unless specified otherwise, do not require that the apparatus be constructed or operated in a particular orientation.

As used herein, terms such as “attached,” “affixed,” “connected,” “coupled,” “interconnected,” and the like refer to a relationship wherein structures are secured or attached to one another either directly or indirectly through intervening structures, as well as both movable or rigid attachments or relationships, unless expressly described otherwise. Accordingly, the disclosure is not limited to such examples illustrating certain combinations of features that may exist alone or in combination with other features.

The present disclosure relates to coating compositions, methods for making coating compositions, and panels coated with the disclosed coating compositions. The disclosure utilizes a coating composition designed for ultra-deep base paints, such as dark red and black paints, having a light reflectance value of less than 40 with sufficient hiding properties and tinting ability, for deep base paints, and for light base paints, such as white paints. In one example, the disclosure yields a black coating composition having a light reflectance value of about 4 to about 7. However, it is understood that any color having a light reflectance value of less than 40 may be achieved by the present disclosure.

In one or more examples, the coating composition includes at least one biocide, such as an antimicrobial or antifungal additive. The biocide includes zinc. In one example, the biocide is present in an amount from about 0.01 wt. % to about 1 wt. %, based on the dry weight of the composition. In another example, the biocide is present in an amount from about 0.05 wt. % to about 0.8 wt. %, based on the dry weight of the composition. In yet another example, the biocide is present in an amount from about 0.05 wt. % to about 0.7 wt. %, based on the dry weight of the composition. The biocide may be present at 0.1 wt. %, 0.2 wt. %, 0.3 wt. %, 0.4 wt. %, 0.5 wt. %, 0.6 wt. %, 0.7 wt. %, 0.8 wt. %, 0.9 wt. %, or 1.0 wt. %, including all ranges and sub-ranges between.

In one example, the biocide includes zinc borate. It has been unexpectedly discovered that zinc borate advantageously provides desirable antimicrobial and antifungal properties to the coating composition without detrimentally impacting viscosity, acoustic properties, and aesthetic properties.

In one aspect, the disclosed coating composition includes a pigment blend and binder such that the pigment-to-binder ratio is about 3:1 to about 30:1, or from about 10:1 to about 20:1. In another example, the pigment-to-binder ratio is about 4:1 to about 20:1. In another example, the pigment-to-binder ratio is about 5:1 to about 20:1. In one example, the coating composition is an ultra-deep base coting having a pigment-to-binder ratio of about 3:1 to about 6:1. In another example, the coating composition is a deep-base coating have a pigment-to-binder ratio of about 8:1 to about 15:1. In yet another example, the coating composition is a white coating having a pigment-to-binder ratio of about 15:1 to about 30:1 or about 18:1 to about 25:1.

In one or more examples, the disclosed coating composition further includes titanium dioxide at a concentration of about 1 wt. % to about 35 wt. %, or from about 5 wt. % to about 25 wt. %, based upon the dry weight of the coating composition. The pigment-to-binder ratio is specifically designed to optimize the material and optical properties to yield improved burnish resistance of the coating composition without impacting the hiding power of the coating composition.

In one or more examples, the disclosed coating composition includes a pigment blend. The pigment blend includes a mix of pigments and fillers, such as titanium dioxide extenders, designed to adequately cover panels, such as ceiling panels, as seams between the acoustic panels, while maintaining desired material properties, such as acoustical and optical. The disclosed coating composition allows for optimal porosity and airflow to achieve desired acoustical properties.

In one or more examples, the pigment blend includes calcium carbonate. In one example, the calcium carbonate is present in an amount from about 20 wt. % to about 60 wt. %, based on the dry weight of the composition. In another example, the calcium carbonate is present in an amount from about 25 wt. % to about 35 wt. %, based on the dry weight of the composition. In yet another example, the calcium carbonate is present in an amount from about 27.0 wt. % to about 32.5 wt. %, based on the dry weight of the composition.

In one or more examples, the pigment blend includes titanium dioxide. The titanium dioxide may be present at any concentration needed to achieve the desired pigment-to-binder ratio as described herein. In one example, the titanium dioxide is present at a concentration from about 0.1 wt. % to about 35 wt. %, based upon the dry weight of the composition. In another example, the titanium dioxide is present at a concentration from about 0.5 wt. % to about 30 wt. %, based upon the dry weight of the composition. In yet another example, the titanium dioxide is present at a concentration from about 3 wt. % to about 25 wt. %, based upon the dry weight of the composition. In another example, the titanium dioxide is present at a concentration from about 1 wt. % to about 2 wt. %, based upon the dry weight of the composition.

In one or more examples, the pigment blend includes calcined diatomaceous earth. The calcined diatomaceous earth may be present at any concentration needed to achieve the desired Pigment-to-binder ratio as described herein. In one example, the calcined diatomaceous earth is present in an amount from about 3 wt. % to about 20 wt. %, based on the dry weight of the composition. In another example, the calcined diatomaceous earth is present in an amount from about 5 wt. % to about 17.5 wt. %, based on the dry weight of the composition. In yet another example, the calcined diatomaceous earth is present in an amount from about 7.5 wt. % to about 15 wt. %, based on the dry weight of the composition.

In one or more examples, the Pigment blend includes aluminum hydroxide. The aluminum hydroxide may be present at any concentration needed to achieve the desired Pigment-to-binder ratio as described herein. In one example, the aluminum hydroxide is present in an amount from about 3 wt. % to about 20 wt. %, based on the dry weight of the composition. In another example, the aluminum hydroxide is present in an amount from about 5 wt. % to about 18 wt. %, based on the dry weight of the composition. In yet another example, the aluminum hydroxide is present in an amount from about 10 wt. % to about 15 wt. %, based on the dry weight of the composition.

The coating composition further includes a binder. In one example, the binder comprises vinyl acrylic polymer, such as polyvinyl acrylic. In another example, the binder comprises polyvinyl, acetate. Other examples of suitable binders include acrylic, alkyd, polystyrene, polyurethane, polyvinyl chloride, polyvinyl, polyolefin, polyester, silicon type and the related co-polymers.

The binder is present at any concentration needed to achieve the desired pigment-to-binder ratio as described herein. In one example, the binder is present in an amount from about 2 wt. % to about 35 wt. %, based on the dry weight of the composition. In another example, the binder is present in an amount from about 2 wt. % to about 18 wt. %, based on the dry weight of the composition. In yet another example, the binder is present in an amount from about 3 wt. % to about 16 wt. %, based on the dry weight of the composition.

In certain examples, the vinyl acrylic polymer is anionic and has a Tg of about 37° C. In certain examples, the vinyl acrylic polymer has a viscosity of about 30 cP, as measured by Brookfield LVT #2 at 60 rpm. In another example, the vinyl acrylic polymer has a pH of about 7.0. In yet another example, the vinyl acrylic polymer has a solids content of about 50%. In certain embodiments, the vinyl acrylic polymer has a specific gravity of about 1.08.

The amount of pigment blend and binder may be defined by a ratio of pigment-to-binder. In one or more examples, the ratio of pigment-to-binder is from about 3:1 to about 30:1. In another example, the pigment-to-binder ratio is about 4:1 to about 20:1. In another example, the pigment-to-binder ratio is about 5:1 to about 20:1. In one example, the coating composition is an ultra-deep base coting having a pigment-to-binder ratio of about 3:1 to about 6:1. In another example, the coating composition is a deep-base coating have a pigment-to-binder ratio of about 8:1 to about 15:1. In yet another example, the coating composition is a white coating having a pigment-to-binder ratio of about 15:1 to about 30:1 or about 18:1 to about 25:1.

The coating composition may further include a solvent. In one example, the solvent is water. In one example, the water is present in an amount from about 10 wt. % to about 35 wt. %, based upon the wet weight of the composition. In another example, the water is present in an amount from about 12 wt. % to about 18 wt. %, based upon the wet weight of the composition. In yet another example, the water is present in an amount from about 13 wt. % to about 15 wt. %, based upon the wet weight of the composition.

In one or more examples, the coating composition further includes a hydrophobic polymer emulsion. In one example, the hydrophobic polymer emulsion is present in an amount from about 0.1 wt. % to about 10 wt. %, based on the dry weight of the composition. In another example, the hydrophobic polymer emulsion is present in an amount from about 0.5 wt. % to about 5.0 wt. %, based on the dry weight of the composition. In yet another example, the hydrophobic polymer emulsion is present in an amount from about 0.75 wt. % to about 3 wt. %, based on the dry weight of the composition.

The coating composition optionally includes a wetting and dispersing additive. In one example, the wetting and dispersing additive includes an anionic copolymer. The wetting and dispersing additive may have an acid value of about 2 mg KOH/g. In one example, the wetting and dispersing additive is present in an amount from about 0.1 wt. % to about 5 wt. %, based on the dry weight of the composition. In another example, the wetting and dispersing additive is present in an amount from about 0.1 wt. % to about 2 wt. %, based on the dry weight of the composition. In yet another example, the wetting and dispersing additive is present in an amount from about 0.1 wt. % to about 0.5 wt. %, based on the dry weight of the composition.

The coating composition includes a clay, such as hectorite or bentonite clay. In one example, the clay is present in an amount from about 0.01 wt. % to about 5 wt. %, based on the dry weight of the composition. In another example, the clay is present in an amount from about 0.03 wt. % to about 2 wt. %, based on the dry weight of the composition. In yet another example, the clay is present in an amount from about 0.03 wt. % to about 0.5 wt. %, based on the dry weight of the composition. The clay may offer an aspect ratio beneficial for achieving aesthetic and acoustic properties.

The coating composition optionally includes a defoamer. The defoamer may include wax and/or mineral oil. In one example, the defoamer is present in an amount from about 0.01 wt. % to about 2 wt. %, based on the dry weight of the composition. In another example, the defoamer is present in an amount from about 0.01 wt. % to about 1 wt. %, based on the dry weight of the composition. In yet another example, the defoamer is present in an amount from about 0.01 wt. % to about 0.1 wt. %, based on the dry weight of the composition.

The pigment blend of the coating composition optionally includes a precipitated synthetic silicate additive. In one example, the precipitated synthetic silicate is present in an amount from 1 wt. % to about 5 wt. %, based on the dry weight of the composition. In another example, the precipitated synthetic silicate is present in an amount from about 1.5 wt. % to about 3.5 wt. %, based on the dry weight of the composition. In yet another example, the precipitated synthetic silicate is present in an amount from about 2 wt. % to about 3 wt. %, based on the dry weight of the composition.

The pigment blend of the coating composition optionally includes a calcined extender additive. In one example, the calcined extender is present in an amount from about 1 wt. % to about 30 wt. %, based on the dry weight of the composition. In another example, the calcined extender is present in an amount from about 2 wt. % to about 5 wt. %, based on the dry weight of the composition. In yet another example, the calcined extender is present in an amount from about 3 wt. % to about 4 wt. %, based on the dry weight of the composition.

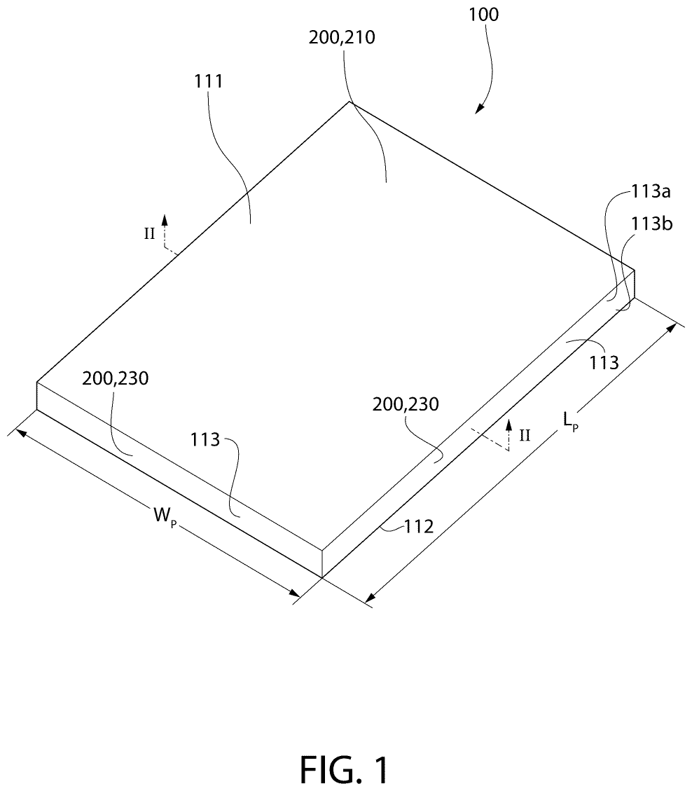

Referring to FIGS. 1 through 6, also disclosed are panels, such as ceiling or wall panels. In one example, the acoustic panels are acoustical panels having appropriate acoustical characteristics for the specified application. Some non-limiting examples of panel materials that may be used include, without limitation, mineral fiber board, fiberglass, metals, polymers, wood, composites, combinations thereof, or other. Examples of panels have a sufficiently high noise reduction coefficient (NRC) and ceiling attenuation class (CAC) rating to be characterized as an acoustical substrate in contrast to gypsum-based drywall having substantially lower NRCs (e.g. 0.05) characteristic of sound reflecting, not absorbing materials. NRC is a measure of sound energy absorption of a material. An NRC rating of 0 is a perfect sound reflection material. An NRC rating of 1 is a perfect sound absorption material. CAC is a measure for rating the performance of a ceiling material as a barrier to block airborne sound transmission through the material to/from the plenum above the ceiling. In one or more examples, the disclosed panel 100 with the coating composition 200 yields a NRC rating of about 0.8.

In certain examples, the disclosed panel may comprise one or more fire retardants. In certain examples, the fire retardant is selected from magnesium oxide, sodium silicate, magnesium sulfate, calcium carbonate, aluminum trihydrate, ammonium polyphosphate, or a combination thereof. The one or more fire retardants may be present at various amounts or concentrations. In certain examples, the one or more fire retardants are present in an amount from about 50 wt. % to about 95 wt. %. In certain embodiments, magnesium oxide may be present in an amount from about 10 to about 85 wt. %. In another example, sodium silicate may be present in an amount from about 10 to about 25 wt. %. In yet another example, magnesium sulfate may be present in an amount from about 5 to about 10 wt. %. In a further example, calcium carbonate may be present in an amount from about 5 to about 10 wt. %.

In some examples, the acoustic panels according to the present disclosure may have an NRC of at least 0.50 and/or CAC of at least 230 depending on the desired acoustical characteristics of the ceiling system. In a certain example, the NRC rating may be at least 0.70. The shiplap and tongue-in-groove edge details may be formed by any fabrication process or combination of processes capable of making the details. Non-limiting examples include cutting, routing, milling, casting, molding, etc.

In some examples, the disclosed panels may be composite structures formed from two or more separately formed layers or sheets of material which are bonded or joined together to form a complete panel.

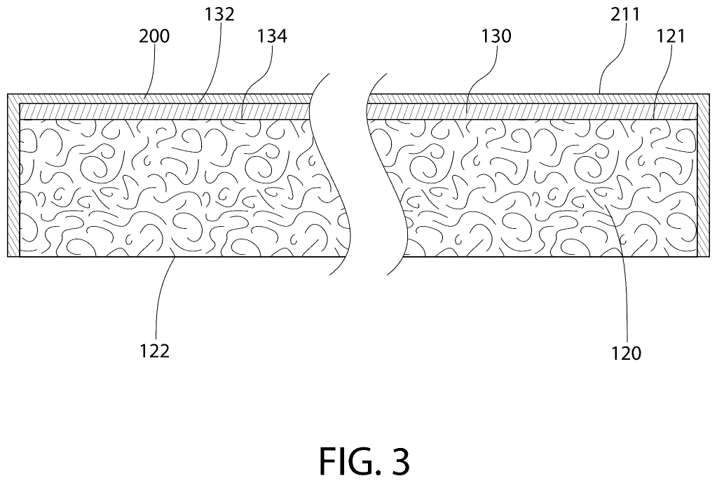

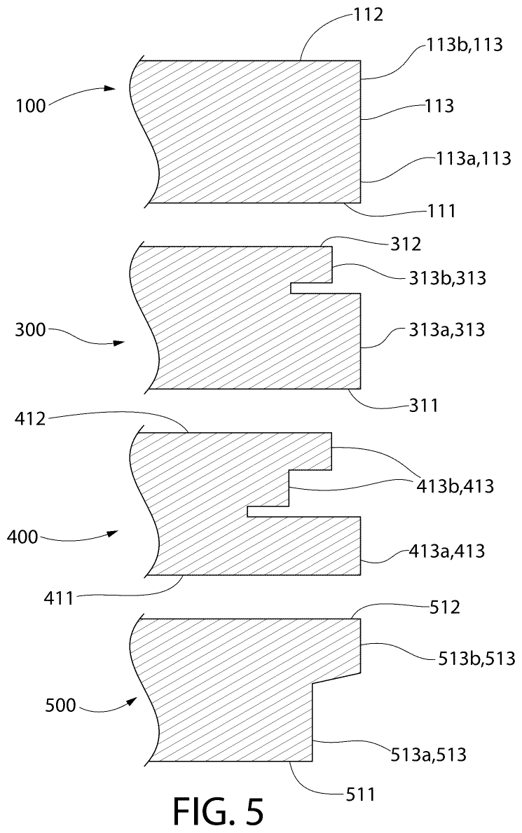

Referring to FIGS. 1 and 5, in certain aspects, the present disclosure includes a coated panel 100 (referred to herein as “building panel”) comprising a first major surface 111 opposite a second major surface 112 and a side surface 113 that extends between the first major surface 111 and the second major surface 112, thereby defining a perimeter of the ceiling panel 100. In certain examples, the side surface 113 may comprise an upper portion 113a and a lower portion 113b, wherein the upper portion 113a is adjacent to the first major surface 111 and the lower portion 113b is adjacent to the second major surface 112. In other examples, as shown in FIG. 3, the building panel 100 may include a scrim 130 coupled to one of the first major surface 111 or the second major surface 112 via an adhesive.

The building panel 100 may have an acoustic panel thickness to as measured from the first major surface 111 to the second major surface 112. The acoustic panel thickness to may range from about 5 mm to about 40 mm-including all values and sub-ranges there-between. The building panel 100 may have a length Lₚ ranging from about 30 cm to about 310 cm-including all values and sub-ranges there—the building panel 100 may have a width Wₚ ranging from about 10 cm to about 125 cm-including all values and sub-ranges there-between. The density of the building panel may vary. In certain examples, the density of the building panel is from about 0.3 g/cm3 to about 1.5 g/cm³. In certain examples, the building panel density is from about 0.4 g/cm3 to about 0.9 g/cm³. In further examples, the building panel density is from about 0.5 g/cm3 g/cm3 to about 0.7 g/cm3.

The building panel 100 comprises a body 120 and a surface coating 200 applied thereto—as discussed further herein. The body 120 comprises an upper surface 121 opposite a lower surface 122 and a body side surface 123 that extends between the upper surface 121 and the lower surface 122, thereby defining a perimeter of the body 120. The body 120 may have a body thickness t₁ that extends from the upper surface 121 to the lower surface 122. The body thickness t₁ may range from about 5 mm to about 40 mm-including all values and sub-ranges there-between. The body 120 may be porous, thereby allowing airflow through the body 120 between the upper surface 121 and the lower surface 122. The body 120 may be comprised of a binder and fibers. In some examples, the body 120 may further comprise a filler and/or additive.

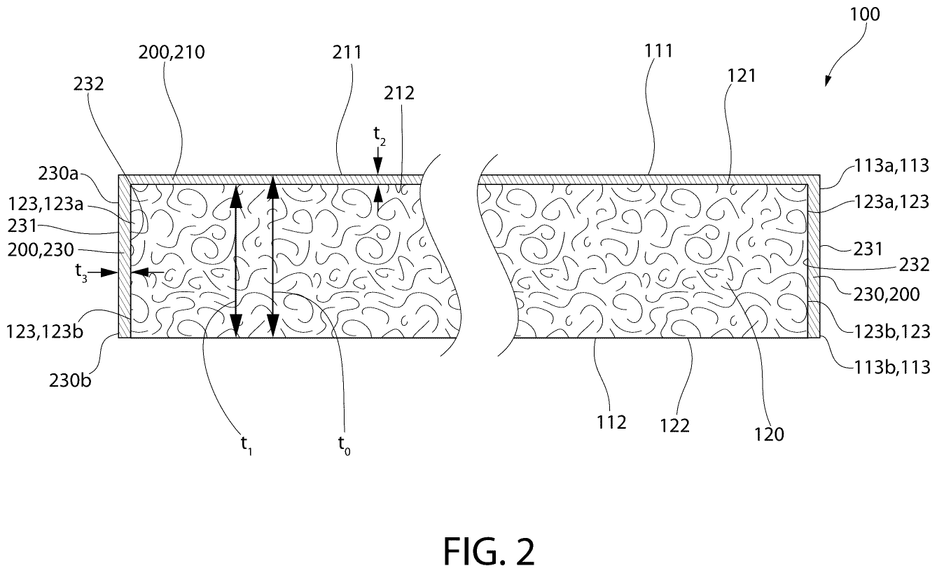

FIG. 2 shows an example where a coating 200 is present on the upper surface 121 and body side surface 123 of the body 120. In other examples, the coating 200 may be only on the upper surface 121, the lower surface 122, the body side surface 123, or a combination thereof. The coating 200 comprises a first side 211 opposite a second side 212. The coating 200 may have a thickness t₂ as measured from the first side 211 to the second side 212. One of skill in the art would recognize that a scrim 130 may be applied between the coating 200 and the body 120 without deviating from the disclosure. Where a coating is present, the total thickness to of the building panel 100 includes the thickness of the coating 200.

FIG. 3 illustrates an example where a scrim 130 is present on the upper surface 121 of the body 120 and the coating 200 is present on a first major scrim surface 132. The scrim 130 includes a first major scrim surface 132 opposite a second major scrim surface 134. The coating 200 comprises a first side 211 opposite a second side 212. The coating 200 may have a thickness t₂ as measured from the first side 211 to the second side 212. One of skill in the art would recognize that the scrim 130 may be positioned between the coating 200 and the body 120 or over the coating 200 without deviating from the disclosure. Where a coating 200 and scrim 130 are present, the total thickness to of the building panel 100 includes the thickness of the coating 200 and the scrim 130.

In certain examples, the building panel may be embossed. Embossment allows for enhanced visual effects of the building panel. For example, various designs and visual depths may be introduced with embossment. In certain examples, the building panel may be embossed with various patterns including, but not limited to, woodgrain, smooth or rough textures. Standard methods may be used for the embossment.

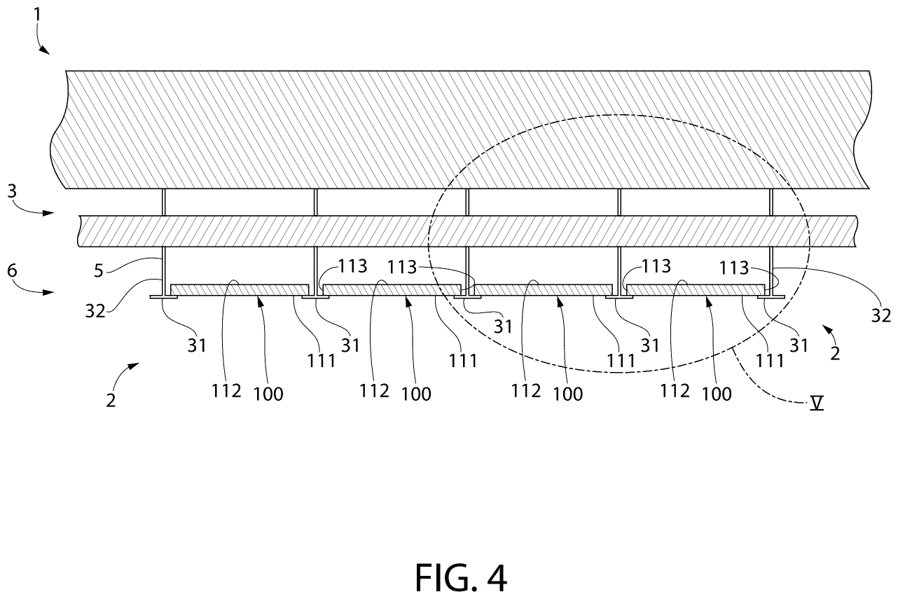

The present disclosure may further include a ceiling system. FIG. 4 shows an example of a ceiling system 1 comprising one or more of the building panels 100 installed in an interior space, whereby the interior space comprises a plenum space 3 and an active room environment 2. The building panels 100 may be joined together via a joint compound. Any all-purpose, commercially-available joint compound material may be used without departing from the scope of the disclosure. The present disclosure is designed such that the coating 200 may be applied over both the building panels 100 and joint compound connecting the building panels 100 and offer desirable hiding power for both the acoustic panels 100, scrim 130 if present over the acoustic panels 100, and joint compound.

The plenum space 3 provides space for mechanical lines within a building (e.g., HVAC, plumbing, etc.). The active space 2 provides room for the building occupants during normal intended use of the building (e.g., in an office building, the active space would be occupied by offices containing computers, lamps, etc.). In the installed state, the building panels 100 may be supported in the interior space by one or more parallel support struts 5. Each of the support struts 5 may comprise an inverted T-bar having a horizontal flange 31 and a vertical web 32. The ceiling system 1 may further comprise a plurality of first struts that are substantially parallel to each other and a plurality of second struts that are substantially perpendicular to the first struts (not pictured). In some examples, the plurality of second struts intersects the plurality of first struts to create an intersecting ceiling support grid 6. The plenum space 3 exists above the ceiling support grid 6 and the active room environment 2 exists below the ceiling support grid 6.

In the installed state, the first major surface 111 of the building panel 100 may face the active room environment 2 and the second major surface 112 of the building panel 100 may face the plenum space 3. The building panel 100 may be installed according to at least two variations. In a first variation, the building panel 100 is positioned entirely above the horizontal flange 31 of the support struts 5. In the first variation, at least a portion of the first major surface may be concealed from the active room environment 2 by the horizontal flange 31 because the horizontal flange 31 contacts the first major surface 111, thereby supporting it in the ceiling system 1. In a first variation, the entire side surface 113-including the upper portion 113a and the lower portion 113b—may be concealed from the active room environment 2 by the horizontal flange 311. A second variation will be described further herein.

Referring now to FIG. 5, examples of building panels 300, 400, 500 are illustrated in accordance with other aspects of the present disclosure. The building panels 300, 400, and 500 are similar to building panel 100 except as described herein below. The description of building panel 100 above generally applies to building panels 300, 400, and 500 described below except with regard to the differences specifically noted below. A similar numbering scheme will be used for the building panels 300, 400, and 500 as with building panel 100 except that the 300-, 400-, and 500-series of numbers will be used.

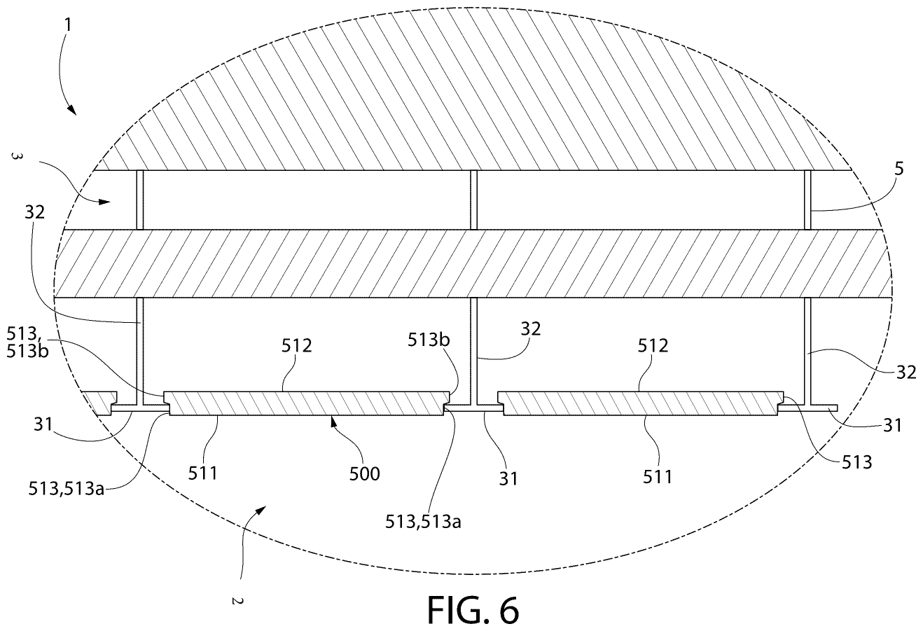

Referring now to FIG. 6, the building panel 500 may be installed according to a second variation, as described herein. The building panel 500 may be positioned such that the upper portion 513a of the side surface 513 is below the horizontal flange 31, thereby extending into the active room environment 2. The lower portion 513b of the side surface 513 is above the horizontal flange 31 extending into the plenum space 3. The first major surface 511 and the upper portion 513a of the side surface 513 of the building panel 500 is exposed to the active room environment 2. The lower portion 513b of the side surface 513 may be concealed from the active room environment 2. The lower portion 513b of the side surface 513 may be adjacent to at least a portion of the vertical web 32 as viewed along a horizontal direction. The lower portion 513b of the side surface 513 as well as the second major surface 512 may be exposed to the plenum space 3.

In one or more examples, the upper portion 513a and the lower portion 513b may comprise the surface coating 200. In certain examples, the first major surface 511 may comprise the surface coating 200. Therefore, in certain examples, the surface coating 200 may be exposed to the active room environment on the first major surface 511 and the upper portion 513a of the side surface 513 of the building panel 500 in the installed state.

One of skill in the art would appreciate that the coating composition may also be used in other ceiling systems. Therefore, the examples described above are non-limiting examples.

In other examples, the coated building panel of the disclosure may be used as a surface covering system. In certain examples, the surface covering system comprises a system of panels, each panel comprising a first building panel having a rectangular shape, a first major surface opposite a second major surface and side surfaces extending there-between, a second building panel having a rectangular shape, a first major surface opposite a second major surface and side surfaces extending there-between, a third building panel having a rectangular shape, a first major surface opposite a second major surface and side surfaces extending there-between, wherein the first major surface of the first building panel is in contact with the second major surface of the second building panel, the first major surface of the second building panel is in contact with the second major surface of the third building panel, and wherein the side surfaces of the first building panel and the side surfaces of the third building panel are parallel and the side surfaces of the first building panel and the side surfaces of the second building panel are not parallel. Any one or more of the acoustic panels and/or panel surfaces may be covered by the inventive coating composition.

The inventive coated building panel may be attached to a substrate, thus creating a surface covering system. Without intending to be limited, the building panel may be included in a removable surface covering system using adhesive components as disclosed in U.S. Patent Application No. 2019/0270275, filed Mar. 2, 2019. For example, in certain examples, the disclosure is a surface covering system as described herein, further comprising an adhesive tape configured to detachably couple The acoustic panels to a substrate, the adhesive tape comprising a substrate-side adhesive component comprising at least one adhesive layer; An acoustic panel-side adhesive component comprising at least one adhesive layer; and a release component; wherein The acoustic panels are detachably coupled to the substrate by the adhesive tape in a side-by-side arrangement to cover the substrate, the at least one adhesive layer of the substrate-side adhesive component being adhered to the substrate, the at least one adhesive layer of the acoustic panel-side adhesive component being adhered to the rear surfaces of the acoustic panels, and the release component being positioned between the substrate-side adhesive component and the acoustic panel-side adhesive component. In other examples, the surface covering system comprises an adhesive tape configured to detachably couple the acoustic panels to a substrate, the adhesive tape comprising an acoustic panel-side adhesive component comprising at least one adhesive layer; an optional substrate-side adhesive component comprising at least one adhesive layer; and an optional release component; wherein the acoustic panels are detachably coupled to the substrate by the adhesive tape in a side-by-side arrangement to cover the substrate, the at least one adhesive layer of the substrate-side adhesive component being adhered to the substrate, the at least one adhesive layer of the acoustic panel-side adhesive component being adhered to the rear surfaces of the acoustic panels, and the release component being positioned between the substrate-side adhesive component and the acoustic panel-side adhesive component.

In other examples, the acoustic building panel may be directly attached to a substrate using one or more attaching means. In certain examples, attachment may be accomplished by use of one or more of clips, screw, or adhesive. Various adhesives are known in the art. In a certain non-limiting example, the adhesive is made from synthetic rubber and resin. In certain examples, the synthetic rubber and resin has a viscosity of about 230,000 cps. In certain examples, the synthetic rubber and resin has a flash point of about −17° C. In another non-limiting example, the adhesive is a water-based rubber resin. In another non-limiting example, the adhesive is a two-component cross-linking diisocyanate waterborne emulsion. In other examples, the adhesive is an aqueous polyvinyl acetate emulsion. In certain examples, a water-based adhesive using emulsion polymer isocyanate may be used. In other examples, a polyurethane based adhesive may be used. In some examples the adhesive may be a pressure sensitive adhesive, a hot melt adhesive, or a combination thereof. In some examples, the adhesive comprises a hot melt adhesive. In some examples, the adhesive comprises a pressure sensitive adhesive. In some examples, the adhesive comprises polyvinyl acetate. In some examples, the adhesive comprises ethylene vinyl-acetate (EVA).

In certain examples, the adhesive is applied at 3 to 30 g/ft². In certain examples, the adhesive is applied at 10 to 25 g/ft². In certain examples, the adhesive is applied at 12 to 20 g/ft². In certain examples, the adhesive is a two-component cross-linking diisocyanate waterborne emulsion applied at 10 to 25 g/ft². In certain examples, the adhesive is a two-component cross-linking diisocyanate waterborne emulsion applied at 15 to 25 g/ft². In certain examples, the adhesive is an aqueous polyvinyl acetate emulsion applied at 8 to 25 g/ft². In certain examples, the adhesive is an aqueous polyvinyl acetate emulsion applied at 8 to 15 g/ft².

An important characteristic for building materials is the burning performance. ASTM E84-20 provides methods to determine the relative burning behavior of the material. In particular, ASTM E84-20 provides methods for determining the Flame Spread Index (FSI) which characterizes how far flames generated on the test material spread. The FSI is measured from 0 (indicating no flames) to 200 (which indicates spreading flames). ASTM E84-20 also provides methods for determining the Smoke Developed Index (SDI) which states how much smoke is generated. SDI is measured on a scale of 0 to 450, which correlates to no smoke generated (value of 0) to thick, heavy smoke (value of 450). Obtained FSI and SDI values are then compiled and applied to a three-tiered class system: Class A, Class B, and Class C, with Class A rated materials producing minimal to no flames or smoke, while Class C materials producing the most flames or smoke. In order to qualify as an E84 Class A fire rating, a flame spread index (FSI) of 25 or less and smoke developed index (SDI) at 450 or less must be exhibited. In certain examples, the building panel has a flame spread index (FSI) of about 0 to about 10, as determined by ASTM E84-20. In certain examples, the building panel has a flame spread index (FSI) of about 10 as determined by ASTM E84-20. In certain examples, the building panel has a flame spread index (FSI) of about 0 as determined by ASTM E84-20. In certain examples, the building panel has a smoke developed index (SDI) of about 450, or less, as determined by ASTM E84-20. In certain examples, the building panel has a smoke developed index (SDI) of about 350, or less, as determined by ASTM E84-20.

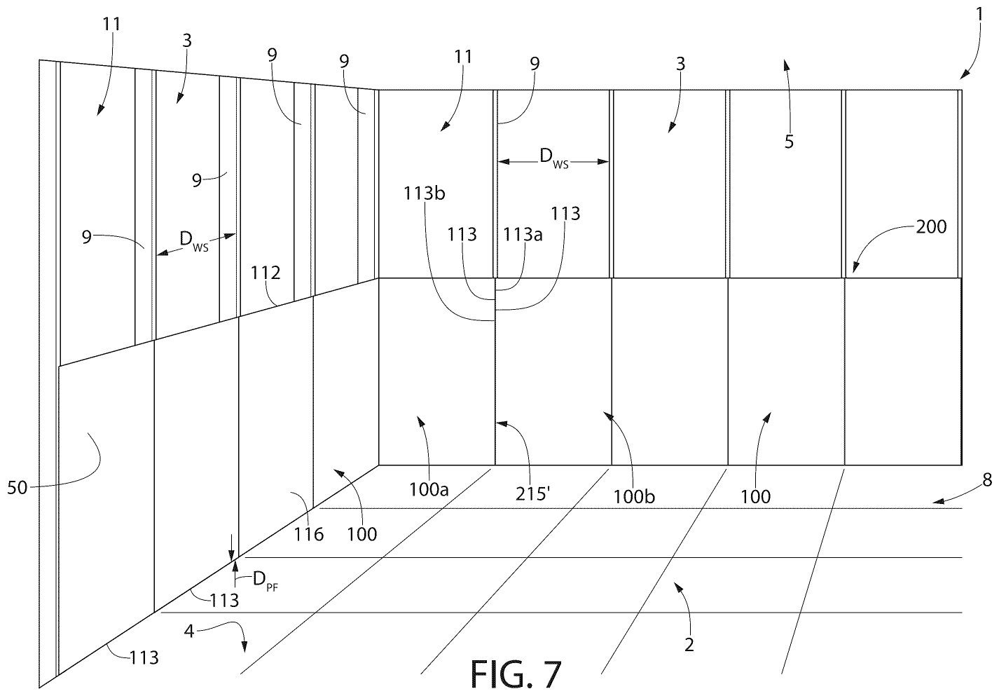

Referring to FIG. 7, in one or more examples, the present disclosure may be implemented in a building system 1. In one example, the present disclosure includes a building system 1 comprising one or more of the acoustic building panels 100 or plurality of acoustic building panels 202 installed in an interior space 8. FIG. 7 shows the acoustic building panel 100 installed, however, the following discussion applies to any configuration disclosed herein.

The interior space 8 may comprise a floor surface 4, equivalent to ground level as disclosed herein, that is opposite a ceiling surface 5. The interior space 8 may further comprise a cavity space 3 and an active room environment 2. The cavity space 3 may provide a free volume for joists and/or wall stud 9 to be located within the acoustic building system 1. The active room environment 2 provides room for the acoustic building occupants during normal intended use of the acoustic building (e.g., in an office building, the active space would be occupied by offices containing computers, lamps, etc.). The floor surface 4 provides for building occupants to walk on within the room environment 2. The floor surface 4 may extend into the cavity space 3. The floor surface 4 may be formed a building material (e.g., wood flooring, concrete flooring, metal grate, etc.).

In the installed state, the acoustic building panels 100, plurality of acoustic building panels 100 may be supported in the interior space 8 by one or more of the wall studs 9 (for acoustic building panels 100 that function as wall panels) and/or one or more of the ceiling joists (for acoustic building panels 100 that function as ceiling panels—not pictured). In the installed state, the plurality of acoustic building panels 100 supported by the wall studs 9 may form a wall surface 50. In the installed state, the plurality of building panels 100 supported by the ceiling joists may form a ceiling surface 5.

The plurality of wall studs 9 may be arranged substantially parallel to each other. The plurality of wall studs 9 may be offset from each other by a distance D_{WS} of about 16 inches—as measured on center from each adjacent wall stud 9. The distance D_{WS} between wall studs 9 may provide for an open cavity volume 11. The open cavity volume 11 may be an unoccupied space within the acoustic building system 1. In other embodiments, insulation may be installed into the open cavity volume 11-non-limiting examples of insulation include sound insulation, thermal insulation, and combinations thereto.

The wall studs 9 may be an elongated body having a substantially vertical orientation-extending in a direction that spans between the floor surface 4 and the ceiling surface 5. Depending on the room layout design, the wall studs 9 may be oriented orthogonal to the floor surface 4—i.e., resulting in a wall surface 50 that is completely vertical (also referred to as a “vertical wall surface” 50). In other embodiments, the wall studs 9 may be oriented at an angle between about 46° to about 89° relative to the floor surface 4—i.e., resulting in a wall surface 50 that is slanted (also referred to as a “slanted wall surface” 50).

Depending on the room layout design, the ceiling surface 5 may be substantially parallel to the floor surface 4—i.e., resulting in a ceiling surface 5 that is completely horizontal (also referred to as a “horizontal ceiling surface” 5). In other embodiments, the ceiling surface 5 may be oriented at an angle between about 1° to about 44° relative to the floor surface 4—i.e., resulting in a ceiling surface 5 that is slanted (also referred to as a “slanted ceiling surface” 5).

The cavity space 3 may exist behind each one of the plurality of acoustic building panels 202. The active room environment 2 may exists in front of each one of the plurality of acoustic building panels 202. The first exposed major surface 116 of each acoustic building panel 100 may face the active room environment 2. The second exposed major surface 118 of each acoustic building panel 100 may face the cavity space 3. As discussed further herein, the acoustic building panels 100 of the present invention have airflow properties required for the acoustic building panels 100 to functional as acoustical building panels—as discussed further herein.

In a non-limiting embodiment, the acoustic building panels 100 may be supported by the one or more of the wall studs 9 using a mechanical fastener (e.g., screw), adhesive, or combinations thereto. In a non-limiting embodiment, the acoustic building panels 100 may be support by the one or more ceiling joists using a mechanical fastener (e.g., screw), adhesive, or combinations thereof.

Each of the acoustic building panels 100 may be positioned within building system I such that at least one of the side exposed surfaces 113 is located adjacent to the floor surface 4. Specifically, the first side surface 113a (or second side surface 113b) may be located adjacent to the floor surface 4-whereby in such arrangement, the wall acoustic building panel 100 is vertically oriented in a sideways manner (not pictured). The wall acoustic building panel 100 vertically oriented in the sideways manner may comprise the third side surface 113c and the fourth side surface 113d being substantially parallel to the elongated body of the wall studs 9-whereby each one of the third side surface 113c and/or fourth side surface 113d may overlap with a single wall stud 9. The wall acoustic building panel 100 vertically oriented in the sideways manner may comprise the first side surface 113a and the second side surface 113b being substantially orthogonal to the elongated body of the wall studs 9-whereby each one of the first side surface 113a and/or second side surface 113b may overlap with a plurality of wall studs 9.

In other embodiments, each of the acoustic building panels 100 may be positioned within building system 1 such that at least one of the side surfaces 113 is located adjacent to the floor surface 4 such that the third side surface 113c (or fourth side surface 113d) may be located adjacent to the floor surface 4-whereby in such arrangement, the wall acoustic building panel 100 is vertically oriented in an upstanding manner. The wall acoustic building panel 100 vertically oriented in the upstanding manner may comprise the first side surface 113a and the second side surface 113b being substantially parallel to the elongated body of the wall studs 9-whereby each one of the first side surface 113a and/or second side surface 113b may overlap with a single wall stud 9. The wall panel 100 vertically oriented in the upstanding manner may comprise the third side surface 113c and the fourth side surface 113d being substantially orthogonal to the elongated body of the wall studs 9-whereby each one of the third side surface 113c and/or fourth side surface 113d may overlap with a plurality of wall studs 9.

In the installed state, the acoustic building panel 100 may be secured to one or more of the wall studs 9 such that the acoustic building panel 100 is located from the floor surface 4 by an acoustic panel-floor distance D_{PF}. The acoustic panel-floor distance D_{PF} may be determined by the vertical distance spanning between the floor surface 4 and the most-proximate point on the acoustic building panel 100 from the floor surface 4. The acoustic panel-floor distance D_{PF} may range from zero to about 7 feet-including all distances and sub-ranges there-between. The acoustic panel-floor distance D_{PF} may range from zero to about 6 feet-including all distances and sub-ranges there-between. When the acoustic panel-floor distance D_{PF} is zero, the acoustic building panel 100 may be in direct contact with the floor surface 4. In some embodiments, the acoustic panel-floor distance D_{PF} is less than about 6 feet.

In another aspect, FIG. 7 demonstrates that a first acoustic building panel 100a and a second acoustic building panel 100b may be positioned adjacent to each other, whereby an acoustic panel seam 215′ is located where the first side surface 113a of the first building panel 100a is located adjacent to the second side surface 113b of the second building panel 100b.

In other embodiments, the acoustic building panel 100 may also be installed such that it forms a ceiling surface (not pictured) and/or be position above the acoustic panel-floor distance D_{PF}.

Furthermore, the disclosed plurality of acoustic building panels 100 includes a first acoustic building panel positioned between ground level and up to 7 ft above ground level. The plurality of acoustic building panels 202 further includes a second acoustic building panel positioned adjacent the first acoustic building panel and more than 7 ft above ground level (not shown).

Also disclosed is a method for forming a building panel 100 comprising a coating composition 200 as shown and described herein. In one example, the method includes mixing two or more of calcium carbonate, titanium dioxide, calcined diatomaceous earth, and aluminum hydroxide with a biocide comprising zinc and a binder in an amount having a pigment-to-binder ratio of about 3:1 to about 30:1 with a solvent, such as water, to form a mixed composition.

In one or more examples, the biocide is present in an amount from about 0.01 wt. % to about 1 wt. %, based on the dry weight of the composition. In another example, the biocide is present in an amount from about 0.05 wt. % to about 0.8 wt. %, based on the dry weight of the composition. In yet another example, the biocide is present in an amount from about 0.05 wt. % to about 0.7 wt. %, based on the dry weight of the composition. The biocide may be present at 0.1 wt. %, 0.2 wt. %, 0.3 wt. %, 0.4 wt. %, 0.5 wt. %, 0.6 wt. %, 0.7 wt. %, 0.8 wt. %, 0.9 wt. %, or 1.0 wt. %, including all ranges and sub-ranges between. In one example, the biocide includes zinc borate.

The method further includes applying the mixed composition to a surface of an acoustic panel 100. In one example, the method includes applying the mixed composition to one of a first major surface 111 and a second major surface 112 of the acoustic panel 100. In another example, the method includes applying the mixed composition to a scrim 130 coupled to the acoustic panel 100.

The method further includes drying the acoustic panel 100 to evaporate the solvent to yield a dry coating composition 200. In one example, the drying is performed at room temperature, i.e. about 20° C. to about 22° C. In another example, the drying is performed at an elevated temperature, such as between 25° C. to about 85° C.

### Examples

The examples and other implementations described herein are exemplary and not intended to be limiting in describing the full scope of compositions and methods of this disclosure. Equivalent changes, modifications and variations of specific implementations, materials, compositions, and methods may be made within the scope of the present disclosure, with substantially similar results. Unless otherwise indicated, all viscosity values are as measured by Brookfield LVT #2 at 10 rpm and 20° C.

The following Tables illustrate exemplary data collected regarding viscosity, color and gloss properties, and mold growth for various compositions including different biocides as well as different compositions including zinc borate as the biocide.

TABLE 1

| | | | | Dry Weight | |
|---|---|---|---|---|---|
| | Wet Amount | % Wet | % Solids | Amount | Dry Weight % |
| Chemistry | (lbs) | Weight (%) | (%) | (lbs) | (%) |
| Deionized water | 1600.80 | 14.73% | 0.00% | 0 | 0.00% |
| Clay | 5.44 | 0.05% | 100.00% | 5.44 | 0.07% |
| Humectant | 217.80 | 2.00% | 65.00% | 141.57 | 1.80% |
| Defoamer | 3.29 | 0.03% | 100.00% | 3.29 | 0.04% |
| Wetting and | 87.83 | 0.81% | 35.00% | 30.74 | 0.39% |
| dispersing additive | | | | | |
| Surfactant | 13.07 | 0.12% | 35.00% | 4.57 | 0.06% |
| Titanium dioxide | 108.90 | 1.00% | 100.00% | 108.90 | 1.39% |
| Pigment | | | | | |
| Pigment | 381.14 | 3.51% | 99.00% | 377.33 | 4.81% |
| flame retardant | 1128.18 | 10.38% | 99.60% | 1123.67 | 14.32% |
| Calcined | 871.18 | 8.01% | 99.70% | 868.57 | 11.07% |
| diatomaceous earth | | | | | |
| Binder | 2474.16 | 22.76% | 50.00% | 1237.08 | 15.76% |
| calcium carbonate | 3391.09 | 31.20% | 99.60% | 3377.52 | 43.04% |
| Precipitated synthetic | 196.02 | 1.80% | 99.00% | 194.06 | 2.47% |
| silicate | | | | | |
| Calcined extender; | 261.36 | 2.40% | 100.00% | 261.36 | 3.33% |
| dispersant | | | | | |
| Biocide | 0.00 | 0.00% | 99.00% | 0.00 | 0.00% |
| Stabilizer | 123.71 | 1.14% | 90.80% | 112.33 | 1.43% |
| Antimicrobial | 6.56 | 0.06% | 24.00% | 1.57 | 0.02% |
| Total Base = | 10870.5 | 0.00% | | 7848.01 | 100.00% |

The coating composition of Table 1 correlates to Comparative 2 for a black coating having no biocide.

TABLE 2

| | Wet | % Wet | | Dry Weight | |
|---|---|---|---|---|---|
| | Amount | Weight | % Solids | Amount | Dry Weight % |
| Chemistry | (lbs) | (%) | (%) | (lbs) | (%) |
| Deionized water | 727.64 | 14.66% | 0.00% | 0 | 0.00% |
| Clay | 2.47 | 0.05% | 100.00% | 2.47 | 0.07% |
| Humectant | 99.00 | 1.99% | 65.00% | 64.35 | 1.79% |
| Defoamer | 1.50 | 0.03% | 100.00% | 1.50 | 0.04% |
| Wetting and | 39.92 | 0.80% | 35.00% | 13.97 | 0.39% |
| dispersing additive | | | | | |
| Surfactant | 5.94 | 0.12% | 35.00% | 2.08 | 0.06% |
| Titanium dioxide | 49.50 | 1.00% | 100.00% | 49.50 | 1.38% |
| Pigment | | | | | |
| Pigment Extender | 173.25 | 3.49% | 99.00% | 171.51 | 4.78% |
| Aluminum | 512.81 | 10.33% | 99.60% | 510.76 | 14.23% |
| hydroxide; flame | | | | | |
| retardant | | | | | |
| Calcined | 395.99 | 7.98% | 99.70% | 394.81 | 11.00% |
| diatomaceous earth | | | | | |
| Binder | 1124.62 | 22.66% | 50.00% | 562.31 | 15.67% |
| calcium carbonate | 1541.40 | 31.06% | 99.60% | 1535.24 | 42.78% |
| Precipitated synthetic | 89.10 | 1.80% | 99.00% | 88.21 | 2.46% |
| silicate | | | | | |
| Calcined extender; | 118.80 | 2.39% | 100.00% | 118.80 | 3.31% |
| dispersant | | | | | |
| Zinc Borate | 22.00 | 0.44% | 99.00% | 21.78 | 0.61% |
| Stabilizer | 56.23 | 1.13% | 90.80% | 51.06 | 1.42% |
| Antimicrobial | 2.98 | 0.06% | 24.00% | 0.72 | 0.02% |
| Total Base = | 4963.2 | 100.00% | | 3589.06 | 100.00% |

The coating composition of Table 2 correlates to Example 3 having zinc borate as a biocide present at 0.61 wt. % based on the total weight of the dry coating.

TABLE 3

| | | % Wet | | | |
|---|---|---|---|---|---|
| | Wet Amount | Weight | % Solids | Dry Weight | Dry Weight % |
| Chemistry | (lbs) | (%) | (%) | Amount (lbs) | (%) |
| Deionized water | 727.64 | 14.70% | 0.00% | 0 | 0.00% |
| Clay | 2.47 | 0.05% | 100.00% | 2.47 | 0.07% |
| Humectant | 99.00 | 2.00% | 65.00% | 64.35 | 1.80% |
| Defoamer | 1.50 | 0.03% | 100.00% | 1.50 | 0.04% |
| Wetting and dispersing | 39.92 | 0.81% | 35.00% | 13.97 | 0.39% |
| additive | | | | | |
| Surfactant | 5.94 | 0.12% | 35.00% | 2.08 | 0.06% |
| Titanium dioxide | 49.50 | 1.00% | 100.00% | 49.50 | 1.38% |
| Pigment | | | | | |
| Pigment Extender | 173.25 | 3.50% | 99.00% | 171.51 | 4.80% |
| Aluminum hydroxide; | 512.81 | 10.36% | 99.60% | 510.76 | 14.28% |
| flame retardant | | | | | |
| Calcined diatomaceous | 395.99 | 8.00% | 99.70% | 394.81 | 11.04% |
| earth | | | | | |
| Binder | 1124.62 | 22.72% | 50.00% | 562.31 | 15.72% |
| calcium carbonate | 1541.40 | 31.14% | 99.60% | 1535.24 | 42.93% |
| Precipitated synthetic | 89.10 | 1.80% | 99.00% | 88.21 | 2.47% |
| silicate | | | | | |
| Calcined extender; | 118.80 | 2.40% | 100.00% | 118.80 | 3.32% |
| dispersant | | | | | |
| Zinc Borate | 8.83 | 0.18% | 99.00% | 8.74 | 0.244% |
| Stabilizer | 56.23 | 1.14% | 90.80% | 51.06 | 1.43% |
| Antimicrobial | 2.98 | 0.06% | 24.00% | 0.72 | 0.02% |
| Total Base = | 4950.0 | 100.00% | | 3576.02 | 100.00% |

The coating composition of Table 3 correlates to Example 2, a black coating having zinc borate as a biocide present at 0.244 wt. % based on the total dry weight of the coating.

TABLE 4

| | Wet | % Wet | | Dry Weight | |
|---|---|---|---|---|---|
| | Amount | Weight | % Solids | Amount | Dry Weight % |
| Chemistry | (lbs) | (%) | (%) | (lbs) | (%) |
| Deionized water | 742.64 | 14.70% | 0.00% | 0 | 0.00% |
| Clay | 2.53 | 0.05% | 100.00% | 2.53 | 0.07% |
| Humectant | 101.04 | 2.00% | 65.00% | 65.68 | 1.80% |
| Defoamer | 1.53 | 0.03% | 100.00% | 1.53 | 0.04% |
| Wetting and dispersing | 40.75 | 0.81% | 35.00% | 14.26 | 0.39% |
| additive | | | | | |
| Surfactant | 6.06 | 0.12% | 35.00% | 2.12 | 0.06% |
| Titanium dioxide Pigment | 303.12 | 6.00% | 100.00% | 303.12 | 8.30% |
| Pigment Extender | 404.16 | 8.00% | 99.00% | 400.12 | 10.95% |
| Calcined extender; | 122.26 | 2.42% | 99.60% | 121.77 | 3.33% |
| dispersant | | | | | |
| Flame retardant | 378.90 | 7.50% | 99.70% | 377.76 | 10.34% |
| Binder | 1147.81 | 22.72% | 50.00% | 573.91 | 15.71% |
| Precipitated synthetic | 101.04 | 2.00% | 99.60% | 100.64 | 2.75% |
| silicate | | | | | |
| Calcined diatomaceous | 293.02 | 5.80% | 99.00% | 290.09 | 7.94% |
| earth | | | | | |
| calcium carbonate | 1337.77 | 26.48% | 100.00% | 1337.77 | 36.62% |
| Zinc borate | 9.01 | 0.18% | 99.00% | 8.92 | 0.24% |
| Stabilizer | 57.39 | 1.14% | 90.80% | 52.11 | 1.43% |
| Antimicrobial | 3.04 | 0.06% | 24.00% | 0.73 | 0.02% |
| Total Base = | 5052.1 | 100.00% | | 3653.04 | 100.00% |

Table 4 includes compositional data for Example 4, a blue coating composition including 0.24 wt. % zinc borate based on the total dry weight of the coating.

TABLE 5

| | | | % | Dry Weight | |
|---|---|---|---|---|---|
| | Amount | % Wet | Solids | Amount | Dry Weight % |
| Chemistry | (grams) | Weight (%) | (%) | (lbs) | (%) |
| Water | 678.10 | 22.45% | 0% | 0.00 | 0.00% |
| Clay | 3.00 | 0.10% | 100% | 3.00 | 0.14% |
| Humectant | 55.81 | 1.85% | 65% | 36.28 | 1.66% |
| Defoamer | 0.80 | 0.03% | 100% | 0.80 | 0.04% |
| Wetting and dispersing additive | 16.80 | 0.56% | 35% | 5.88 | 0.27% |
| Surfactant | 3.57 | 0.12% | 35% | 1.25 | 0.06% |
| Titanium dioxide Pigment | 567.38 | 18.78% | 100% | 567.38 | 25.99% |
| Pigment Extender | 378.05 | 12.52% | 99% | 374.27 | 17.14% |
| Aluminum hydroxide; flame | 161.72 | 5.35% | 100% | 161.08 | 7.38% |
| retardant | | | | | |
| Calcined diatomaceous earth | 235.23 | 7.79% | 100% | 234.53 | 10.74% |
| Binder | 200.73 | 6.65% | 50% | 100.36 | 4.60% |
| calcium carbonate | 668.80 | 22.14% | 100% | 666.12 | 30.51% |
| Stabilizer | 30.00 | 0.99% | 91% | 27.24 | 1.25% |
| Biocide | 18.88 | 0.63% | 25% | 4.72 | 0.22% |
| Antimicrobial | 1.59 | 0.05% | 24% | 0.38 | 0.02% |
| Total = | 3020.47 | 100% | | 2183.29 | 100% |

Table 5 includes compositional data for Example 6, a coating composition including 2-(4-Thiazolyl)benzimidazole, 148-79-8, 25% as a biocide present at 0.22 wt. % based on the total dry weight of the coating.

TABLE 6

| | | | | Dry | |
|---|---|---|---|---|---|
| | | | | Weight | Dry |
| | Amount | % Wet | % Solids | Amount | Weight % |
| Chemistry | (grams) | Weight (%) | (%) | (lbs) | (%) |
| Water | 678.10 | 22.50% | 0% | 0.00 | 0.00% |
| Clay | 3.00 | 0.10% | 100% | 3.00 | 0.14% |
| Humectant | 55.81 | 1.85% | 65% | 36.28 | 1.66% |
| Defoamer | 0.80 | 0.03% | 100% | 0.80 | 0.04% |
| Wetting and dispersing additive | 16.80 | 0.56% | 35% | 5.88 | 0.27% |
| Surfactant | 3.57 | 0.12% | 35% | 1.25 | 0.06% |
| Titanium dioxide Pigment | 567.38 | 18.82% | 100% | 567.38 | 25.99% |
| Pigment Extender | 378.05 | 12.54% | 99% | 374.27 | 17.14% |
| Aluminum hydroxide; flame | 161.72 | 5.37% | 100% | 161.08 | 7.38% |
| retardant | | | | | |
| Calcined diatomaceous earth | 235.23 | 7.80% | 100% | 234.53 | 10.74% |
| Binder | 200.73 | 6.66% | 50% | 100.36 | 4.60% |
| calcium carbonate | 668.80 | 22.19% | 100% | 666.12 | 30.51% |
| Stabilizer | 30.00 | 1.00% | 91% | 27.24 | 1.25% |
| Biocide | 12.63 | 0.42% | 38% | 4.80 | 0.220% |
| Antimicrobial | 1.59 | 0.05% | 24% | 0.38 | 0.02% |
| Total = | 3014.22 | 100% | | 2183.37 | 100% |

Table 6 includes compositional data for Example 7, a coating composition including Bis(2-pyrdylthio-1-oxide) Zinc, 13463-41-7, 38% as a biocide present at 0.22 wt. % based on the total dry weight of the coating.

TABLE 7

| | | % Wet | % Solids | Dry Weight | Dry Weight % |
|---|---|---|---|---|---|
| Chemistry | Amount (grams) | Weight (%) | (%) | Amount (lbs) | (%) |
| Water | 678.10 | 22.56% | 0% | 0.00 | 0.00% |
| Clay | 3.00 | 0.10% | 100% | 3.00 | 0.14% |
| Humectant | 55.81 | 1.86% | 65% | 36.28 | 1.66% |
| Defoamer | 0.80 | 0.03% | 100% | 0.80 | 0.04% |
| Wetting and dispersing | 16.80 | 0.56% | 35% | 5.88 | 0.27% |
| additive | | | | | |
| Surfactant | 3.57 | 0.12% | 35% | 1.25 | 0.06% |
| Titanium dioxide | 567.38 | 18.87% | 100% | 567.38 | 25.99% |
| Pigment | | | | | |
| Pigment Extender | 378.05 | 12.58% | 99% | 374.27 | 17.14% |
| Aluminum hydroxide; | 161.72 | 5.38% | 100% | 161.08 | 7.38% |
| flame retardant | | | | | |
| Calcined diatomaceous | 235.23 | 7.82% | 100% | 234.53 | 10.74% |
| earth | | | | | |
| Binder | 200.73 | 6.68% | 50% | 100.36 | 4.60% |
| Calcium Carbonate | 668.80 | 22.25% | 100% | 666.12 | 30.51% |
| Stabilizer | 30.00 | 1.00% | 91% | 27.24 | 1.25% |
| Biocide | 4.72 | 0.16% | 100% | 4.72 | 0.22% |
| Antimicrobial | 1.59 | 0.05% | 24% | 0.38 | 0.02% |
| Total = | 3006.31 | 100% | | 2183.29 | 100% |

Table 7 includes compositional data for Example 8, a coating composition including 2-bromo-2-nitropropane-1,3-diol (Bronopol), 52-51-7, ˜ 99% as a biocide present at 0.22 wt. % based on the total dry weight of the coating.

TABLE 8

| | | % Wet | | | |
|---|---|---|---|---|---|
| | Amount | Weight | % Solids | Dry Weight Amount | Dry Weight % |
| Chemistry | (grams) | (%) | (%) | (lbs) | (%) |
| Water | 678.10 | 22.55% | 0% | 0.00 | 0.00% |
| Clay | 3.00 | 0.10% | 100% | 3.00 | 0.14% |
| Humectant | 55.81 | 1.86% | 65% | 36.28 | 1.66% |
| Defoamer | 0.80 | 0.03% | 100% | 0.80 | 0.04% |
| Wetting and dispersing | 16.80 | 0.56% | 35% | 5.88 | 0.27% |
| additive | | | | | |
| Surfactant | 3.57 | 0.12% | 35% | 1.25 | 0.06% |
| Titanium dioxide Pigment | 567.38 | 18.87% | 100% | 567.38 | 25.99% |
| Pigment Extender | 378.05 | 12.57% | 99% | 374.27 | 17.14% |
| Flame Retardant | 161.72 | 5.38% | 100% | 161.08 | 7.38% |
| Calcined diatomaceous | 235.23 | 7.82% | 100% | 234.53 | 10.74% |
| earth | | | | | |
| Binder | 200.73 | 6.68% | 50% | 100.36 | 4.60% |
| Calcium carbonate | 668.80 | 22.25% | 100% | 666.12 | 30.51% |
| Stabilizer | 30.00 | 1.00% | 91% | 27.24 | 1.25% |
| Biocide | 4.90 | 0.16% | 100% | 4.88 | 0.22% |
| Antimicrobial | 1.59 | 0.05% | 24% | 0.38 | 0.02% |
| Total = | 3006.49 | 100% | | 2183.45 | 100% |

Table 8 includes compositional data for Example 9, a coating composition including 2-(4-Thiazolyl)benzimidazole, 99.5% as a biocide present at 0.22 wt. % based on the total dry weight of the coating.

TABLE 9

| | | | | Dry | |
|---|---|---|---|---|---|
| | | % Wet | | Weight | Dry |
| | Amount | Weight | % Solids | Amount | Weight % |
| Chemistry | (grams) | (%) | (%) | (lbs) | (%) |
| Water | 678.10 | 22.55% | 0% | 0.00 | 0.00% |
| Clay | 3.00 | 0.10% | 100% | 3.00 | 0.14% |
| Humectant | 55.81 | 1.86% | 65% | 36.28 | 1.66% |
| Defoamer | 0.80 | 0.03% | 100% | 0.80 | 0.04% |
| Wetting and dispersing | 16.80 | 0.56% | 35% | 5.88 | 0.27% |
| additive | | | | | |
| Surfactant | 3.57 | 0.12% | 35% | 1.25 | 0.06% |
| Titanium dioxide | 567.38 | 18.87% | 100% | 567.38 | 25.99% |
| Pigment | | | | | |
| Pigment Extender | 378.05 | 12.57% | 99% | 374.27 | 17.14% |
| Flame retardant | 161.72 | 5.38% | 100% | 161.08 | 7.38% |
| Calcined diatomaceous | 235.23 | 7.82% | 100% | 234.53 | 10.74% |
| earth | | | | | |
| Binder | 200.73 | 6.68% | 50% | 100.36 | 4.60% |
| Calcium Carbonate | 668.80 | 22.24% | 100% | 666.12 | 30.51% |
| Stabilizer | 30.00 | 1.00% | 91% | 27.24 | 1.25% |
| Zinc Borate | 4.95 | 0.16% | 99% | 4.89 | 0.22% |
| Antimicrobial | 1.59 | 0.05% | 24% | 0.38 | 0.02% |
| Total = | 3006.54 | 100% | | 2183.46 | 100% |

Table 9 includes compositional data for Example 10. a coating composition including zinc borate as a biocide present at 0.22 wt. % based on the total dry weight of the coating.

TABLE 10

| | | % Wet | % Solids | Dry Weight | Dry Weight % |
|---|---|---|---|---|---|
| Chemistry | Amount (grams) | Weight (%) | (%) | Amount (lbs) | (%) |
| Water | 454.33 | 22.52% | 0% | 0.00 | 0.00% |
| Clay | 1.80 | 0.09% | 100% | 1.80 | 0.12% |
| Humectant | 37.39 | 1.85% | 65% | 24.30 | 1.66% |
| Defoamer | 0.53 | 0.03% | 100% | 0.53 | 0.04% |
| Wetting and dispersing | 14.28 | 0.71% | 35% | 5.00 | 0.34% |
| additive | | | | | |
| Surfactant | 2.39 | 0.12% | 35% | 0.84 | 0.06% |
| Titanium Dioxide Pigment | 380.15 | 18.85% | 100% | 380.15 | 25.97% |
| Pigment Extender | 253.30 | 12.56% | 99% | 250.76 | 17.13% |
| Flame Retardant | 108.35 | 5.37% | 100% | 107.92 | 7.37% |
| Calcined diatomaceous earth | 157.61 | 7.81% | 100% | 157.13 | 10.73% |
| Binder | 134.49 | 6.67% | 50% | 67.24 | 4.59% |
| Calcium Carbonate | 448.09 | 22.21% | 100% | 446.30 | 30.49% |
| Zinc Borate | 3.32 | 0.16% | 99% | 3.28 | 0.22% |
| Stabilizer | 20.10 | 1.00% | 91% | 18.25 | 1.25% |
| Antimicrobial | 1.07 | 0.05% | 24% | 0.26 | 0.02% |
| Total = | 2017.19 | 100.00% | | 1463.77 | 100% |

Table 10 includes compositional data for Example 1. a white paint composition including zinc borate.

TABLE 11

| | | % Wet Weight | % Solids | Dry Weight | Dry Weight |
|---|---|---|---|---|---|
| Chemistry | Wet Amount (lbs) | (%) | (%) | Amount (lbs) | % (%) |
| Water | 742.64 | 14.70% | 0.00% | 0 | 0.00% |
| Clay | 2.53 | 0.05% | 100.00% | 2.53 | 0.07% |
| Humectant | 101.04 | 2.00% | 65.00% | 65.68 | 1.80% |
| Defoamer | 1.53 | 0.03% | 100.00% | 1.53 | 0.04% |
| Wetting and | 40.75 | 0.81% | 35.00% | 14.26 | 0.39% |
| dispersing additive | | | | | |
| Surfactant | 6.06 | 0.12% | 35.00% | 2.12 | 0.06% |
| Titanium Dioxide | 303.12 | 6.00% | 100.00% | 303.12 | 8.31% |
| Pigment | | | | | |
| Pigment Extender | 404.16 | 8.00% | 99.00% | 400.12 | 10.97% |
| Flame Retardant | 122.26 | 2.42% | 99.60% | 121.77 | 3.34% |
| Calcined | 378.90 | 7.50% | 99.70% | 377.76 | 10.35% |
| diatomaceous earth | | | | | |
| Binder | 1147.81 | 22.72% | 50.00% | 573.91 | 15.73% |
| Calcium Carbonate | 101.04 | 2.00% | 99.60% | 100.64 | 2.76% |
| Humectant | 293.02 | 5.80% | 99.00% | 290.09 | 7.95% |
| Defoamer | 1337.77 | 26.48% | 100.00% | 1337.77 | 36.67% |
| Stabilizer | 57.39 | 1.14% | 90.80% | 52.11 | 1.43% |
| Antimicrobial | 9.01 | 0.18% | 50.00% | 4.51 | 0.12% |
| Antimicrobial | 3.04 | 0.06% | 24.00% | 0.73 | 0.02% |
| Total Base = | 5052.1 | 100.00% | | 3648.63 | 100.00% |

Table 11 includes compositional data for Comparative 3. a deep-base coating composition.

TABLE 12

| Sample | Chemistry | Week 1 | Week 2 | Week 3 | Week 4 |
|---|---|---|---|---|---|
| Example 6 | 2-(4-Thiazolyl)benzimidazole, 148-79-8, 25% | 10 | 8.3 | 2.0 | 0.0 |
| Example 7 | Bis(2-pyrdylthio-1-oxide) Zinc, 13463-41-7, 38% | 10 | 9.3 | 9.0 | 8.7 |
| Example 8 | 2-bromo-2-nitropropane-1,3-diol (Bronopol), 52-51-7, ~99% | 10 | 7.7 | 6.0 | 4.0 |
| Example 9 | 2-(4-Thiazolyl)benzimidazole, 148-79-8, 25% | 10 | 8.0 | 7.3 | 5.7 |
| Example 10 | Zinc Borate, 138265-88-0, 98.8% | 10 | 10.0 | 9.0 | 7.7 |
| Example 1 | ZB 0.22% (dry) | 10.0 | 9.7 | 8.7 | 8.3 |
| Example 2 | ZB 0.24% (dry) | 9.3 | 7.7 | 5.7 | 5.3 |
| Example 3 | ZB 0.61% (dry) | 10.0 | 8.0 | 5.7 | 5.0 |
| Example 2 | ZB 0.24% (dry) | 10.0 | 8.0 | 7.0 | 6.3 |
| Example 11 | ZP+ 0.24% (dry) | 10.0 | 9.0 | 9.0 | 8.0 |
| Example 2 | ZB 0.24% (dry) | 9.3 | 7.7 | 5.7 | 5.3 |

Table 12 exhibits mold test data collected for various Examples and Comparatives. The Mold Testing was done in accordance with the testing procedures of ASTM D3273 at 0.02% dry. Results of a 5.0 or higher are acceptable values for passing the mold test. The various Examples include compositions including biocides other than zinc borate as compared to Examples of compositions including zinc borate at different concentrations and with different pigment blends for white, black, and blue coatings.

TABLE 13

| | | | | Spindle, Viscosity (rpm, cps) | | | |
|---|---|---|---|---|---|---|---|
| Sample | Solids | lbs./gal | pH | 0.5 | 10 | 60 | 100 |
| Compar- | 70.03 | 14.92 | 7.75 | 31000 | 3130 | 1053 | 816 |
| ative 1 | | | | | | | |
| Example 1 | 72.88 | 15.12 | 8.41 | 27,200 | 2,980 | 1,088 | 868 |
| Compar- | 71.59 | 13.34 | 8.59 | 5,400 | 1,590 | 788.3 | 674 |
| ative 2 | | | | | | | |
| Example 2 | 71.37 | 13.44 | 8.49 | 2,800 | 1,160 | 660 | 586 |
| Example 3 | 67.21 | 12.7 | 8.53 | 2,800 | 1,020 | 612 | 519 |
| Compar- | 70.47 | 12.89 | 8.49 | 11,000 | 2,140 | 950 | 818 |
| ative 3 | | | | | | | |
| Example 4 | 72.27 | 12.55 | 8.34 | 10,200 | 2,100 | 940 | 798 |
| Compar- | | 13.05 | 8.23 | 7,400 | 1,410 | 668.3 | 510 |
| ative 3 | | | | | | | |
| Example 4 | | 12.26 | 8.39 | 7,800 | 1,600 | 673.3 | 544 |

Table 13 illustrates data regarding initial viscosity of the Example compositions and Comparatives.

TABLE 14

| Formula | L | a | b | 20° | 60° | 85° | Delta E | Delta L | Delta a | Delta b |
|---|---|---|---|---|---|---|---|---|---|---|
| Comparative 1 | 94.37 | −0.64 | 3.03 | 1.20 | 1.30 | 0.15 | 0.27 | −0.18 | −0.01 | 0.20 |
| Example 1 | 93.51 | −0.67 | 2.83 | 1.20 | 1.25 | 0.15 | 0.16 | 0.04 | 0.01 | 0.16 |
| Comparative 2 | 24.48 | 0.26 | −0.18 | 0.05 | 0.15 | 0.10 | 0.29 | −0.26 | −0.04 | −0.12 |
| Example 2 | 24.04 | 0.36 | −0.10 | 0.00 | 0.15 | 0.10 | 0.37 | −0.32 | −0.05 | −0.17 |
| Example 3 | 22.38 | 0.47 | 0.19 | 0.00 | 0.10 | 0.10 | 0.42 | −0.30 | 0.00 | −0.29 |
| Comparative 4 | 67.55 | −2.75 | 1.45 | 0.50 | 0.60 | 0.10 | 0.47 | −0.43 | −0.03 | −0.18 |
| Example 4 | 71.13 | −3.03 | 2.34 | 0.60 | 0.70 | 0.10 | 0.63 | −0.59 | −0.02 | −0.20 |

The data in Table 14 illustrates Jar test effect on color after exposure for 1 day. Testing conditions included exposure to 145° F. and 100% RH.

TABLE 15

| | | | | | Delta | Delta | Delta | Delta |
|---|---|---|---|---|---|---|---|---|
| | L | a | b | Y | E | L | a | b |
| Comparative 1 | 94.64 | −0.86 | 3.83 | 86.77 | | | | |
| Example 1 | 94.29 | −0.89 | 3.13 | 85.96 | 0.79 | −0.34 | −0.03 | −0.71 |
| Comparative 2 | 23.03 | 0.44 | 0.12 | 3.81 | | | | |
| Example 2 | 22.90 | 0.52 | 0.14 | 3.77 | 0.15 | −0.13 | 0.08 | 0.01 |
| Example 3 | 22.73 | 0.58 | 0.27 | 3.72 | 0.36 | −0.30 | 0.14 | 0.15 |
| Comparative 3 | 69.67 | −3.42 | 3.10 | 40.28 | | | | |
| Example 4 | 71.29 | −3.38 | 2.96 | 42.61 | 1.62 | 1.62 | 0.04 | −0.14 |
| Comparative 3 | 69.75 | −2.57 | 1.55 | 40.40 | | | | |
| Example 4 | 71.36 | −2.59 | 1.54 | 42.71 | 1.60 | 1.60 | −0.03 | −0.01 |

Table 15 illustrates data collected for various boards and joint compound sprayed with the Example compositions. The joint compound was applied to the boards and air dried for overnight, then sanded. Four layers of the Example compositions were then applied to the boards at 12 g/sf each, 250° F. oven dry for 3 minutes for each layer.

As supported by the data above, it has been discovered that zinc borate advantageously provides desirable antimicrobial and antifungal properties to the coating composition without detrimentally impacting viscosity, acoustic properties, and aesthetic properties, and without being harmful from an environmental perspective when compared to other biocides.

While the present disclosure has been described with reference to several examples, which examples have been set forth in considerable detail for the purposes of making a complete disclosure of the disclosure, such examples are merely representative and are not intended to be limiting or represent an exhaustive enumeration of all aspects of the disclosure. The scope of the disclosure is to be determined from the claims appended hereto. Further, it will be apparent to those of skill in the art that numerous changes may be made in such details without departing from the spirit and the principles of the disclosure.

1. A coating composition comprising:
a pigment blend comprising two or more of:
calcium carbonate;
titanium dioxide;
calcined diatomaceous earth; and
aluminum hydroxide;
a biocide comprising zinc;
a clay; and
a binder, wherein a ratio of pigment-to-binder is from about 3:1 to about 30:1.

2. The coating composition of claim 1, wherein the pigment-to-binder ratio is about 5:1.

3. The coating composition of claim 1, wherein the binder comprises vinyl acrylic polymer.

4. The coating composition of claim 1, wherein the binder is present in an amount from about 2 wt. % to about 35 wt. %, from about 2 wt. % to about 18 wt. %, or from about 3 wt. % to about 16 wt. %, based on the dry weight of the composition.

5. The coating composition of claim 1, wherein the titanium dioxide is present at a concentration of about 0.1 wt. % to about 35 wt. % based upon the dry weight of the composition.

6. The coating composition of claim 1, wherein the calcined diatomaceous earth is present in an amount from about 3 wt. % to about 20 wt. % based on the dry weight of the composition.

7. The coating composition of claim 1, wherein the aluminum hydroxide is present in an amount from about 3 wt. % to about 20 wt. %, based on the dry weight of the composition.

8. The coating composition of claim 1, wherein the calcium carbonate is present in an amount from about 20 wt. % to about 60 wt. %, based on the dry weight of the composition.

9-21. (canceled)

22. The coating composition of claim 1, wherein the biocide comprises zinc borate.

23. The coating composition of any one of claim, wherein the biocide is present in an amount from about 0.01 wt. % to about 1 wt. %, based on the dry weight of the composition.

24-27. The coating composition of claim 1, wherein the pigment blend further comprises precipitated synthetic silicate.

28. An acoustic panel comprising a first major surface opposite a second major surface and a side surface extending there-between, the acoustic panel coated on at least one surface with a coating composition comprising:
a pigment blend comprising two or more of:
calcium carbonate;
titanium dioxide;
calcined diatomaceous earth; and
aluminum hydroxide;
a biocide comprising zinc;
a clay; and
a binder, wherein a ratio of pigment-to-binder is from about 3:1 to about 30:1.

29. The acoustic panel of claim 28, wherein the pigment-to-binder ratio is about 5:1.

30. The acoustic panel of claim 28, wherein the binder comprises vinyl acrylic polymer.

31-48. (canceled)

49. The acoustic panel of claim 28, wherein the wherein the biocide comprises zinc borate.

50. The acoustic panel of claim 28, wherein the biocide is present in an amount from about 0.01 wt. % to about 1 wt. %, based on the dry weight of the composition.

51-54. (canceled)

55. The acoustic panel of claim 28, wherein the acoustic panel comprises mineral fiber board, fiberglass, jute fiber, wood, or a composite material.

56. The acoustic panel of claim 28, wherein the acoustic panel is a ceiling or wall panel.

88. A method for forming an acoustic building panel comprising a coating composition, the method comprising:
mixing two or more of calcium carbonate, titanium dioxide, calcined diatomaceous earth, and aluminum hydroxide with clay, a biocide comprising zinc, and a binder in an amount having a pigment-to-binder ratio of about 3:1 to about 30:1 with a solvent to form a mixed composition;
applying the mixed composition to a surface of an acoustic panel; and
drying the acoustic panel to evaporate the solvent to yield a dry coating composition.

89-109. (canceled)

110. The method of claim 88, wherein the biocide comprises zinc borate.

111-116. (canceled)

117. The method of claim 88, wherein the mixed composition is applied to a scrim coupled to the acoustic panel.

118. (canceled)
